(19) United States
(12) Patent Application Publication
(10) Pub. No.: US 2026/0001418 A1
(43) Pub. Date: Jan. 1, 2026

(54) ELECTRIC VEHICLE WITHOUT ON BOARD CHARGER

(71) Applicants: Geun Hie RIM, Seoul (KR); Young Il KIM, Seoul (KR)

(72) Inventors: Geun Hie RIM, Seoul (KR); Young Il KIM, Seoul (KR)

(21) Appl. No.: 18/979,666

(22) Filed: Dec. 13, 2024

(30) Foreign Application Priority Data
Jun. 28, 2024 (KR) 10-2024-0085016

(51) Int. Cl. B60L 53/16; B60L 53/10; B60L 53/30

(52) U.S. Cl. CPC B60L 53/16; B60L 53/11; B60L 53/305

(57) ABSTRACT

The present invention relates to an electric vehicle, wherein the electric vehicle comprises a power supply device that receives single-phase or three-phase AC power from an external source, a charging connector that is connected to the power supply device and has an OBC-grade DC slow connector or DC fast connector that can connect and connect the DC power converted through a power conversion device to an inlet mounted on the electric vehicle, a power conversion device that receives single-phase or three-phase AC power from the power supply device or receives only three-phase AC and converts it into DC and supplies charging power to a battery pack with a BMS built-in for the electric vehicle through the charging connector and has a display unit 330 that allows a user to check the charger status and the charging status of the battery pack, and a power conversion device that controls the charging system in an integrated manner and communicates with the BMS through either a PLC modem or a CAN communication. A DC slow charging system for an externally installed electric vehicle that replaces the OBC function is configured with a communication control unit means that controls charging and displays the presence or absence of a DC supply on the display unit regardless of whether an OBC is installed in the electric vehicle, and wherein the OBC-grade DC slow connector or the DC connector for rapid charging is characterized in that either one of the DC connectors is selected by the user of the electric vehicle and connected to the inlet of the electric vehicle, thereby implementing an electric vehicle without an OBC, thereby reducing the sales cost of the electric vehicle since there is no need for an OBC and wiring according to OBC installation, preventing electrical fires caused by failure or malfunction of the OBC, improving the driving range due to a reduction in the weight of the vehicle, and significantly reducing the reliability and manufacturing cost of the charging system with an integrated communication system.

### CROSS-REFERENCE TO RELATED APPLICATION

The present application claims priority under 35 U.S.C § 119 (a) to Korea Patent Application No. 10-2024-0085016 filed on Jun. 28, 2024, which is hereby expressly incorporated by reference, in its entirety, into the present application.

### BACKGROUND

### 1. Technical Field

The present invention relates to EV (electric vehicle), and more specifically to an EV without OBC that can perform slow charging in the same manner as rapid charging by converting single-phase or three-phase alternating current to direct current outside the electric vehicle without an OBC (On Board Charger) inside the electric vehicle.

### 2. Related Art

Generally, the method of charging an electric vehicle is to connect a single-phase or three-phase alternating current (AC) power source to the connector of the electric vehicle, and to charge battery after converting AC power to DC power using an On Board Charger (OBC) installed inside the electric vehicle. After converting it to direct current (DC), it is boosted or stepped down to electrically insulated primary and secondary sides and slowly charge the electric energy in the battery installed in the electric vehicle.

The slow charger used a single-phase 3.3 kW when the electric vehicle battery capacity was less than 30 kWh, but recently, as the battery capacity of domestic electric vehicles increased from 70 kWh to 100 kWh, it increased to 7 kW. In Europe, slow chargers are sometimes used with 3-phase AC power, and in this case, the number of connector pins is 7 (see Type 2/Europa IEC 62196-2 in FIG. 4).

In addition, when using three-phase alternating current (AC) power with a large power capacity, alternating current (AC) is converted into direct current (DC) through a large-capacity power conversion device (AC-DC, DC-DC conversion) installed on the ground. The battery installed in the car is quickly charged. The fast charger rectifies three-phase alternating current of 50 kW or more into direct current and can charge from 150V to 1,000V DC. Recently, fast chargers up to 100 kW, 200 kW, and 360 kW are being installed.

In this charging method, fast charging inlets and slow charging inlets were installed separately in electric vehicles, but recently produced electric vehicles have an integrated inlet (inlet) that can be charged with a slow charging AC connector or a fast charging DC connector. It has a combined Inlet structure. This allows the user to select either a slow charge or a fast charge connector to enable slow or fast charging. In other words, in the case of recently released domestic electric vehicles, except for low-priced electric vehicles, most are using the CCS (Combined Charging System), which allows both slow charging and fast charging, and is often called a combo type (FIG. 4 SAE J1772/IEC 62196-3).

In particular, in the case of electric vehicles equipped with OBC (On Board Charger), overcharging due to wiring, etc. may cause fire due to failure or malfunction of the OBC and the OBC increases the vehicle weight of the electric vehicle, and resulting in the rise of price. In other words, most existing electric vehicles are equipped with OBC, so slow charging is possible by connecting the connector to an outlet at home. OBC is a charger built into an electric vehicle whose voltage, output, and stability are specified according to the IEC 61851-22 international standard. OBC is largely composed of DC-DC converter and AC-DC converter.

The DC-DC converter is responsible for converting the output voltage of the electric vehicle charger to match the battery charging voltage, and the AC-DC converter is responsible for converting alternating current power into direct current power. OBC is largely divided into single-phase OBC and three-phase OBC. Single-phase OBC can be used by connecting to a single-phase AC power source, and three-phase OBC can be used by connecting to a three-phase AC power source. Charging time takes 4 to 8 hours depending on the capacity of the battery installed in the vehicle. Single-phase 3.3 kW OBC was used when the battery capacity was within 30 kWh, but recently, as the battery capacity of automobiles has increased from 70 kWh to 100 kWh, a 7 kW-class OBC (On Board Charger) is being used. When connecting an AC single phase, 5 pins, or when connecting 3 phases, as in European countries you can charge by connecting the 7-pin connector. These OBCs are installed in electric vehicles and can be charged without a separate charger. Although the charging speed is slow, they can be conveniently used at home or in public places. However, the expensive OBC installation cost increases the selling price of electric vehicles, and the double communication system resulting from OBC installation makes wiring complicated, which not only causes fires due to OBC failures and defects, but also increases the weight of electric vehicles. As this increases, the efficiency of the battery decreases, making it disadvantageous for long distance driving.

Meanwhile, according to Republic of Korea Patent Publication (B1) No. 10-1489226 (2015 Feb. 6.), an integrated slow charger for electric vehicles equipped with OBC (On Board Charger) is disclosed.

However, the above patented technology still suffers from the above problems because an expensive OBC (On Board Charger) is installed inside the electric vehicle.

### SUMMARY

Therefore, the purpose of the present invention is to solve the problems of the prior art, and integrate communication with the AC-DC and DC-DC power conversion devices installed outside the vehicle without the 7 kW OBC (On Board Charger) installed in the electric vehicle. By converting single-phase or three-phase AC power to direct current through the control unit, slow charging is possible using the same method as fast charging, thereby reducing the sales cost of electric vehicles by eliminating the need for wiring for OBC and OBC installation., prevents electrical fires caused by failure or malfunction of the OBC, and provides an electric vehicle without OBC that improves mileage by reducing vehicle weight and significantly reduces charging system reliability and production costs through an integrated communication system.

According to the features of the present invention for achieving the above-mentioned purpose, in an electric vehicle, the electric vehicle comprises a power supply device 100 that receives single-phase or three-phase AC power from the outside, a charging connector 200 that is connected to the power supply device 100 and has an OBC-grade DC slow connector 210 or DC fast connector 220 that can connect and connect the DC power converted through the power conversion device 300 to an inlet mounted on the electric vehicle, a power conversion device 300 that receives single-phase or three-phase AC power from the power supply device 100 or receives only three-phase AC and converts it into DC and supplies charging power to a battery pack 20 with a BMS built-in for the electric vehicle through the charging connector 200 and has a display unit 330 that allows a user to check the charger status and the charging status of the battery pack, and a charging system that integrates and controls a charging system and uses either a PLC modem or CAN communication. The present invention provides an electric vehicle without an OBC, which comprises an externally installed electric vehicle DC slow charging system that controls charging through communication with the BMS and displays on the display unit 330 whether DC is supplied regardless of whether an OBC 10 is installed in the electric vehicle, and wherein the OBC-grade DC slow connector 210 or the DC connector for rapid charging 220 is characterized in that either one of the DC connectors is selected by a user of the electric vehicle and connected to the inlet of the electric vehicle.

According to another embodiment of the present invention, the OBC-less electric vehicle is characterized in that it can be charged only by a DC slow charging system and a rapid charging system even without an OBC installed.

According to another embodiment of the present invention, the electric vehicle without the OBC is characterized in that it can be directly charged at a slow speed by converting single-phase or three-phase AC power into direct current by the power conversion device 300 even without the OBC installed.

According to another embodiment of the present invention, the electric vehicle without the OBC is characterized in that wired PLC (Power Line Communication) communication is possible between the charger and the electric vehicle during slow or rapid charging using the terminal of the charging connector 200.

According to another embodiment of the present invention, the electric vehicle without OBC is characterized in that wireless CAN (Controller Area Network) communication is possible between the charger and the electric vehicle during slow or rapid charging without using the terminal of the charging connector 200.

According to another embodiment of the present invention, the electric vehicle without the OBC is characterized in that it is capable of converting the direct current electric energy stored in the BMS-built battery pack 20 into a single-phase or three-phase alternating current output using an internal or external power conversion device (inverter).

An EV without OBC according to a preferred embodiment of the present invention has the following effects.
(1) Since the present invention does not require an OBC and OBC-related wiring, it can prevent fire caused by failure or malfunction of the OBC and improve battery efficiency by reducing the weight of the vehicle, thereby increasing the driving distance.
(2) Since the present invention does not require separate communication devices for AC slow charging and rapid charging, such as for an electric vehicle equipped with an OBC, a highly reliable communication system can be established through a connector connection between a power conversion device and an electric vehicle.
(3) The present invention can drastically reduce the cost of producing an electric vehicle by eliminating the need for OBC and OBC-related wiring inside the vehicle and simplifying the communication system.

### BRIEF DESCRIPTION OF THE DRAWINGS

FIG. 1 is a drawing showing the prior art.

FIG. 2 is a charging concept diagram for an externally installed electric vehicle DC slow charging system replacing an OBC function according to a preferred embodiment of the present invention.

FIG. 3 is a block diagram showing a detailed technical configuration for an electric vehicle without an OBC according to a preferred embodiment of the present invention.

FIG. 4 is a real-life photograph showing various connectors for an externally installed electric vehicle DC slow charging system replacing an OBC function according to a preferred embodiment of the present invention.

FIG. 5 is a flow chart of a communication control program for an externally installed electric vehicle DC slow charging system replacing an OBC function according to a preferred embodiment of the present invention.

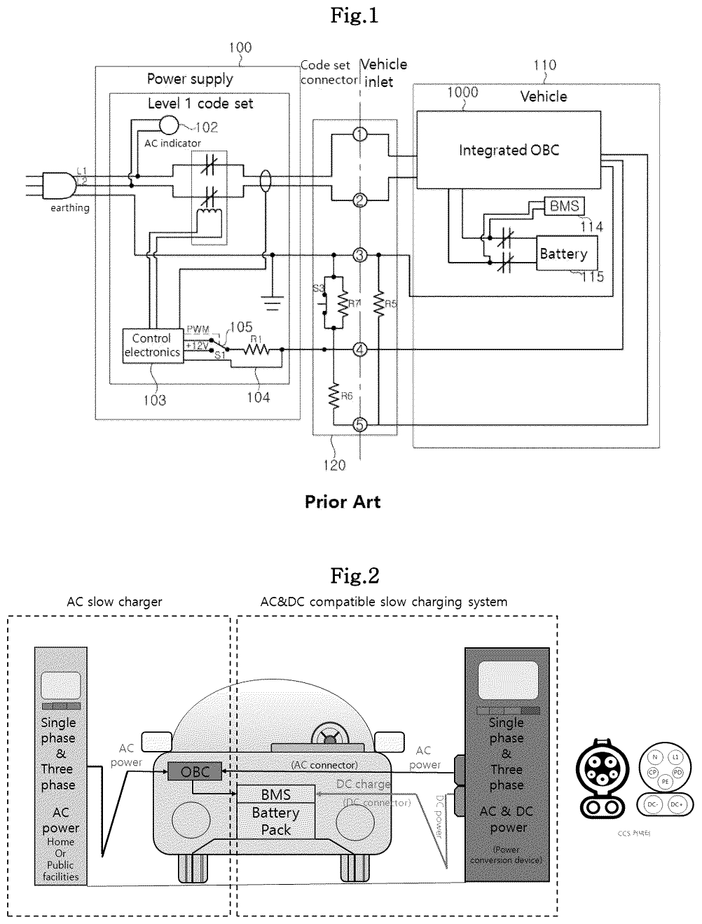

### DETAILED DESCRIPTION OF THE PREFERRED EMBODIMENT

Below, preferred embodiments of the present invention will be described in detail with reference to the attached drawings. First, when adding reference numerals to components of each drawing, it should be noted that the same numerals are used for the same components even if they are shown in different drawings, and even if the same numerals are shown in the prior art, the prior art should be interpreted as such. In addition, when describing the present invention, a detailed description of a related known configuration or function that may obscure the gist of the present invention will be omitted.

Referring to FIGS. 2 to 5, prior to a detailed description of an electric vehicle without an OBC (On Board Charger) according to a preferred embodiment of the present invention, unlike an OBC (On Board Charger) mounted inside a conventional electric vehicle, the core technical components of an externally installed electric vehicle DC slow charging system that replaces the OBC function include a power supply device 100, a charging connector 200, a power conversion device 300, and a communication control unit 400.

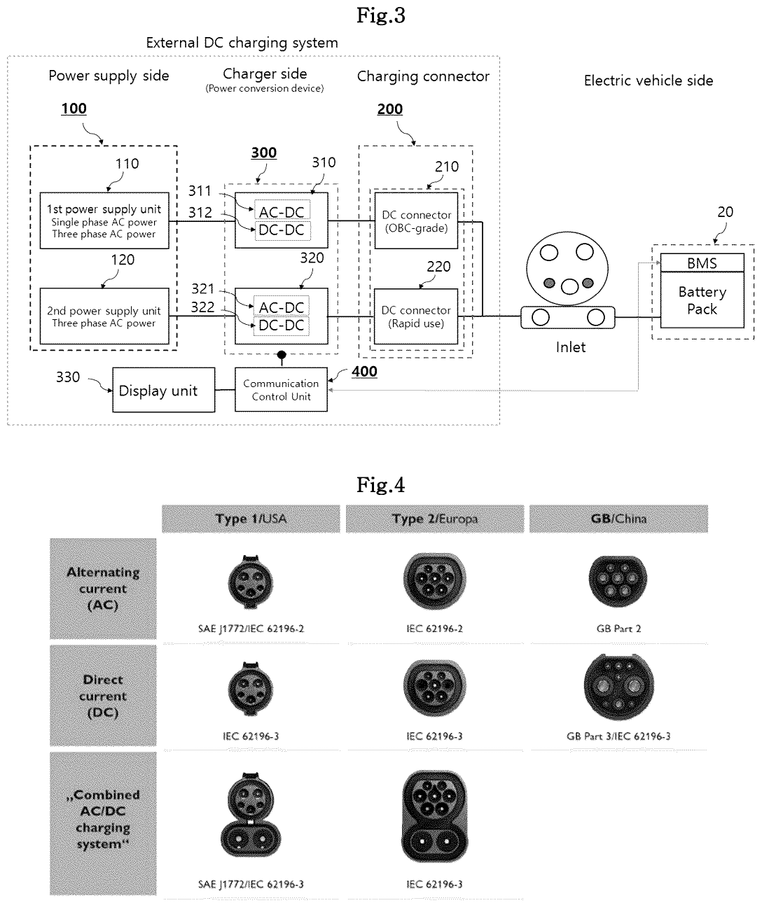

First, referring to FIGS. 2 and 3, the power supply device 100 according to the embodiment of the present invention is a means for receiving external AC power, and is a means for receiving single-phase or three-phase AC power from the outside.

In addition, the power supply device 100 according to the embodiment of the present invention is equipped with a first power supply device 110 that supplies single-phase or three-phase AC to an OBC-class power conversion device 310 of the power conversion device 300 and a second power supply device 120 that supplies only three-phase AC to a power conversion device 320 for a rapid charger of the power conversion device 200.

Here, the power supply device 100 according to the embodiment of the present invention is configured in two modes as a first power supply device 110 and a second power supply device 120, which provides a method of converting single-phase or three-phase alternating current (AC) power from outside the vehicle into direct current (DC) and slowly charging the BMS-built-in battery pack 20 of the electric vehicle directly into direct current (DC) like rapid charging without an OBC installed in the electric vehicle, thereby providing an electric vehicle with a new charging method that reduces the vehicle sales cost due to installation of an OBC like in existing electric vehicles, reduces the weight of the vehicle itself, and increases the battery efficiency to increase the driving distance.

Next, referring to FIG. 3, the charging connector 200 according to an embodiment of the present invention is a means for connecting between the power conversion device 300 and the BMS-embedded battery pack 20 having an inlet, is connected to the power supply device 100, and has an OBC-grade DC connector 210 and a DC connector for a rapid charger that can connect the direct current (DC) power converted by the power conversion device 300 to the inlet mounted on the electric vehicle.

In addition, referring to FIG. 4, the charging connector 200 according to the embodiment of the present invention is manufactured to have an outlet that can be connected to an inlet mounted on the electric vehicle, and when the single-phase or three-phase alternating current (AC) power supplied to the inlet through the OBC-grade DC connector 210 of the charging connector 200 as direct current (DC) power converted through the power conversion device 300, it satisfies the USA (IEC 62196-3), EU (IEC 62196-3), GB & China (GB Part 3 & IEC 62196-3) type charging connector, and the three-phase alternating current (AC) power supplied to the inlet through the DC connector 220 for a rapid charger of the charging connector 200 as direct current (DC) power converted through the power conversion device 300. In this case, it is configured to meet USA (SAE J1772 & IEC 62196-3) and EU (IEC 62196-3) connectors.

In addition, when using the DC connector 210 according to the embodiment of the present invention, a single-phase rectifier circuit or a three-phase rectifier circuit is provided in the power conversion device 300 that converts the single-phase and three-phase alternating current (AC) power into direct current, and each of the rectifier circuits is provided with a PFC (Power Factor Correction, not shown) circuit to minimize reactive power.

Here, the power conversion device 300 includes a PFC (Power Factor Correlation) and a DC-DC converter. The PFC is a means for improving the power factor to minimize reactive power and minimizing EMI (Electro Magnetic Interference) due to harmonics. In other words, the phase of the voltage and current within the power conversion device 300 system must be made the same, and the waveform of the current must be made close to a sine wave. The reason for this is that when the power factor is low, reactive power is generated, so more power is required to create the same active power. This is because it becomes a factor in increasing electricity costs due to electric vehicle charging. In addition, the DC-DC Converter function is a function that adjusts the DC voltage to a desired voltage, and it is necessary to match the required voltage of the electric vehicle battery.

Next, referring to FIGS. 2 and 3, the power conversion device (AC-DC, DC-DC conversion) 300 according to an embodiment of the present invention is a means for converting power from alternating current (AC) to direct current (DC), or from direct current (DC) to direct current (DC) having a different voltage magnitude, and receives single-phase or three-phase alternating current (AC) power from the power supply device 100 or receives only three-phase alternating current (AC) and converts it into direct current (DC) to supply charging power to a battery pack 20 with a built-in BMS for an electric vehicle through the charging connector 200, and has a display unit 330 that allows a user to check the charger status and the charging status of the battery.

Here, the power conversion device 300 is mainly used in a rapid charger that converts three-phase alternating current (AC) of a battery capacity of 50 KW or more into direct current (DC) and can charge up to DC 150 V to 1,000 V. Recently, chargers of up to 100 kW, 200 kW, and 360 kW have been installed, but medium-speed chargers of about 30 kW are also being used. Therefore, the power conversion device 300 according to an embodiment of the present invention has a characteristic in that, in order to overcome the problem of alternating current (AC) slow charging, the capacity of the power conversion device 300 is reduced to that of an OBC installed in a conventional electric vehicle and installed outside the vehicle, thereby enabling direct current (DC) slow charging without an OBC. In addition, the BMS (Battery Management System) has the function of managing the life, performance, and safety of the battery pack, and monitors the temperature, voltage, state of health (SOH), and state of charge (SOC) of each cell in the battery pack. It also has a monitoring function for phenomena that have serious effects on battery cells, such as overcharge, overdischarge, short circuit, and thermal runaway. Therefore, in the embodiment of the present invention, it can be configured so that communication can be made between the communication control unit 400 and the BMS, so that the user can check it through the display unit 330 of the direct current (DC) electric vehicle slow charging system.

In addition, the power conversion device 300 according to the embodiment of the present invention includes an OBC-class power conversion device 310 having an AC-DC Converter 311 that receives single-phase AC power or three-phase AC power from the first power supply device 110 of the power supply device 100 and converts it into direct current, and a DC-DC Converter 312 that synchronizes the DC power input through the AC-DC Convert with the required voltage and charging method of the BMS-built-in battery pack 20, and a power conversion device 320 for a rapid charger having an AC-DC Converter 321 that receives three-phase AC power from the second power supply device 120 of the power supply device 100 and converts it into direct current, and a DC-DC Converter 322 that adjusts the DC power input through the AC-DC Convert to a desired voltage and synchronizes it with the required voltage of the BMS-built-in battery pack 20.

Here, the power conversion device 300 is configured with an OBC-class power conversion device 310 that converts single-phase AC power or three-phase AC power into DC, and a power conversion device 320 for a rapid charger that receives only three-phase AC power and converts it into direct current (DC), which is characterized in that it enables DC slow charging as well as DC rapid charging through a DC electric vehicle slow charging system according to a preferred embodiment of the present invention.

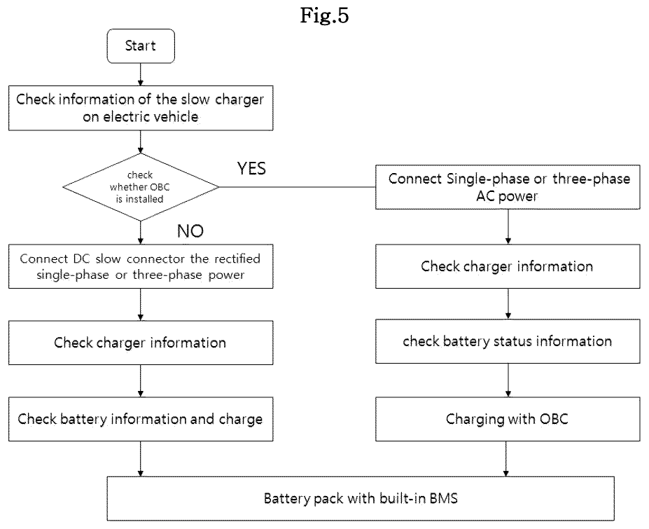

And with reference to FIGS. 3 and 5, the communication control unit 400 according to the embodiment of the present invention is a means for integrated control of the AC and DC compatible electric vehicle slow charging system according to the embodiment of the present invention, is built into the power conversion device 300, is connected to and communicates with a BMS (Battery Management System) that manages the battery pack of the electric vehicle. Unlike conventional electric vehicles, an electric vehicle not equipped with an OBC (On Board Charger) 10 can control charging through communication with the BMS via either a PLC (Power Line Communication) Modem or a CAN (Controller Area Network) communication, and at the same time, display the charging status on the display unit 330 through a direct current (DC) supply, thereby enabling integrated control of the DC slow and rapid charging system.

Here, the PLC (Power Line Communication) Modem is suitable for DC charging as a power line communication modem and supports converting CAN, RS232/485 communication protocols to ISO.IEC 15118 and DIN 70121 standards. It can be installed in a CCS 1 and 2 DC (Combined Charging System) charger or inside an electric vehicle to realize intelligent interconnection between an electric vehicle (EV) and an electric vehicle charging device (Electric Vehicle Supply Equipment, EVSE) such as a charging connector. In addition, the CAN (Controller Area Network) communication is a communication method mainly used in a network within a vehicle such as an automobile, and in the case of an electric vehicle, it can be connected to a battery pack 20 having a BMS to communicate status information according to charging and discharging of the battery pack, etc. In particular, since the CAN bus is a message-based protocol and data is transmitted as a packet called a frame, each frame includes an identifier, data bytes, and control information. At this time, the control information supports error detection and error correction, so that communication errors due to slow or fast charging can be easily identified and problems can be solved. This CAN communication is mainly applied to electric vehicles produced in Japan.

Therefore, in a preferred embodiment of the present invention, in the case of an electric vehicle not equipped with the OBC, by configuring a communication control unit 400 in which either the PLC (Power Line Communication) Modem or the CAN communication communicates with the BMS, each communication system according to the control of slow charger and rapid charger, such as the electric vehicle equipped with the OBC in the past, can be integrated into one communication system by unifying the function of the communication control unit 400 for the control of DC slow charging and rapid charging installed externally.

In addition, the communication control unit 400 according to an embodiment of the present invention includes a step of checking the slow charger information of the electric vehicle to be charged when the user connects the charging connector 300 to the inlet of the electric vehicle, and if the slow charger information is confirmed, comparing and checking whether the OBC (On Board Charger) 10 is installed, and if the OBC is not installed, converting the single-phase or three-phase AC power supplied from the power supply unit 100 into direct current (DC) through the power conversion unit 300, and then displaying and confirming the user to connect the DC slow connector through the display unit 310, and if the DC slow connector is connected, checking the charger information of the electric vehicle to be charged, and if the charger information is confirmed, checking the status information of the BMS built-in battery pack 20 through one of a PWM signal, PLC communication, or CAN communication signal, and then sending a charging command to the BMS built-in battery pack 20. The communication control unit 400 can be programmed to perform the descending steps (see Flow Chart in FIG. 5).

In addition, the communication control unit 400 according to an embodiment of the present invention can control the output voltage of the power conversion device 300 so that, when charging with a direct current (DC) power source through the power conversion device 300, the voltage can be charged according to the voltage required by the BMS-built-in battery pack 20 of the electric vehicle and the CC (Constant Current), CV (Constant Voltage), and CP (Constant Power) according to the charging method, as in the case of rapid charging.

Below, an electric vehicle without an OBC (On Board Charger) according to a preferred embodiment of the present invention will be described in detail.

Here, an electric vehicle without an OBC according to an embodiment of the present invention includes a technical configuration means for a DC electric vehicle slow charging system mentioned above.

That is, an electric vehicle without an OBC (On Board Charger) according to an embodiment of the present invention comprises a power supply device 100 that receives single-phase or three-phase AC power from an external source, a charging connector 200 that is connected to the power supply device 100 and has an OBC-grade DC connector 210 and a DC connector for rapid charging that can connect and connect the DC power converted through a power conversion device 300 to an inlet mounted on the electric vehicle, a power conversion device 300 that receives single-phase or three-phase AC power from the power supply device 100 or receives only three-phase AC and converts it into DC and supplies charging power to a battery pack 20 with a built-in BMS for an electric vehicle through the connector 200, and has a display unit 330 that allows a user to check the status of the charger and the charging status of the battery pack, and a PLC that is built into the power conversion device 300. A DC slow charging system for an externally installed electric vehicle that replaces the OBC function may be included, in which either a modem or a CAN communication controls charging through communication with the BMS, and a communication control unit 400 means for integrating and controlling the charging system displays whether DC is supplied on the display unit 330 regardless of whether an OBC 10 is installed in the electric vehicle.

In addition, an electric vehicle without an OBC (On Board Charger) according to an embodiment of the present invention may be charged by selectively connecting one of the DC connectors among the OBC-grade DC connector 210 or the DC connector for rapid charging 220 of the power conversion device 300 by the user of the electric vehicle.

Here, the configuration to allow selection of the OBC-grade DC connector 210 or the DC connector for rapid charging 220 has the feature of providing convenience to users of electric vehicles without an OBC (On Board Charger) and considering the lifespan of the BMS-embedded battery pack 20.

In addition, the electric vehicle without an OBC (On Board Charger) according to the embodiment of the present invention can be charged with a DC slow charging and rapid charging system even without an OBC installed.

Here, the reason why the DC slow charging and rapid charging system can be charged is that the power conversion device 300 is equipped with an OBC-grade DC connector 210 and a DC connector for rapid charging 220, so that the user can use them selectively, thereby solving the problem of slow charging, which takes 4 to 8 hours depending on the battery capacity of an electric vehicle equipped with an OBC, with DC rapid charging. In particular, this is to provide convenience to users of electric vehicles without an OBC (On Board Charger). For example, it has the feature that allows for leisurely slow charging at home or in public places after work hours, and fast rapid charging when an emergency time such as a business trip is required.

In addition, the electric vehicle without the OBC (On Board Charger) according to the embodiment of the present invention can be directly charged at a slow speed by converting single-phase or three-phase AC power to direct current with the power conversion device 300 even without the OBC installed.

Here, the reason why the direct slow charging is configured is because slow charging is possible through the OBC-grade DC connector 210 equipped in the power conversion device 300, and such slow charging guarantees the life of the BMS-embedded battery pack 10 compared to rapid charging.

In addition, the electric vehicle without the OBC (On Board Charger) according to the embodiment of the present invention can communicate between the charger and the electric vehicle by using the terminal of the charging connector 200 during slow or rapid charging, using a wired PLC (Power Line Communication).

Here, as mentioned above, the PLC (Power Line Communication) Modem is a power line communication modem, and is suitable for a wired communication system according to DC charging, and supports converting CAN, RS232/485 communication protocols to ISO.IEC 15118 and DIN 70121 standards. Communication is done by wired PLC, and charging/discharging is done by DC. The communication channel and the power line are separated by CCS 1 and 2 DC chargers or installed inside the electric vehicle, so that intelligent interconnection between the electric vehicle (EV) and the electric vehicle supply equipment (EVSE), such as the charging connector, can be realized.

In addition, the electric vehicle without the OBC (On Board Charger) according to the embodiment of the present invention can communicate between the charger and the electric vehicle through wireless CAN (Controller Area Network) communication without using the terminal of the charging connector 200 during slow or rapid charging.

Here, the wireless CAN (Controller Area Network) communication is a communication method mainly used in in-vehicle networks such as automobiles, and in the case of electric vehicles, it is connected to a battery pack 20 having a BMS, and wireless communication can be performed using Bluetooth, which is a solution for CAN communication, to check status information according to the charging and discharging of the battery pack.

In addition, the electric vehicle without the OBC (On Board Charger) according to the embodiment of the present invention can output single-phase or three-phase AC using an internal or external power conversion device (inverter) from the direct current electric energy stored in the BMS-built battery pack 20 in the electric vehicle.

Here, when the power converter (inverter) is used, the direct current electric energy stored in the BMS-built battery pack 20 is output as single-phase or three-phase AC using an internal or external power conversion device (inverter), so that it can be used by connecting it to lighting or heating equipment at auto camping sites as well as power tools at construction sites.

The above description is merely an illustrative description of the technical idea of the present invention, and those skilled in the art will appreciate that various modifications and variations can be made without departing from the essential characteristics of the present invention.

Therefore, the embodiments disclosed in the present invention are not intended to limit the technical idea of the present invention but to explain it, and the scope of the technical idea of the present invention is not limited by these embodiments. The protection scope of the present invention should be interpreted by the following claims, and all technical ideas within a scope equivalent thereto should be interpreted as being included in the scope of the rights of the present invention.

1. In an electric vehicle,
the electric vehicle comprises a power supply device that receives single-phase or three-phase AC power from the outside,
a charging connector that is connected to the power supply device and has an OBC-grade DC slow connector or DC fast connector that can connect and connect the DC power converted through the power conversion device to an inlet mounted on the electric vehicle,
a power conversion device that receives single-phase or three-phase AC power from the power supply device or receives only three-phase AC and converts it into DC to supply charging power to a battery pack with a BMS built-in for the electric vehicle through the charging connector, and has a display unit that allows the user to check the charger status and the charging status of the battery pack, and a charging system that is integrated and controlled, and either a PLC modem or a CAN communication device is connected to the BMS. An electric vehicle DC slow charging system for external installation that replaces the OBC function is configured with a communication control unit means that controls charging through communication and displays the presence or absence of DC supply on the display unit 330 regardless of whether an OBC is installed in the electric vehicle, and the EV without OBC is characterized in that either the OBC-grade DC slow connector or the DC connector for rapid charging is selected by the user of the electric vehicle and connected to the inlet of the electric vehicle.

2. The electric vehicle according to claim 1,
Wherein the EV without OBC can be charged by a DC slow charging and rapid charging system even without an OBC installed.

3. The electric vehicle according to claim 1,
Wherein the EV without OBC can be directly charged at a slow speed by converting single-phase or three-phase AC power into direct current by the power conversion device even without an OBC installed.

4. The electric vehicle according to claim 1,
Wherein the EV without OBC communication between the charger and the electric vehicle during slow or rapid charging is possible through wired PLC (Power Line Communication) communication using the terminal of the charging connector.

5. The electric vehicle according to claim 1,
Wherein the EV without OBC wireless CAN (Controller Area Network) communication is possible between the charger and the electric vehicle during slow or rapid charging without using the terminal of the charging connector.

6. The electric vehicle according to claim 1,
Wherein the EV without OBC direct current electric energy stored in the BMS-built battery pack can be converted into single-phase or three-phase alternating current output using an internal or external power conversion device (inverter).
